(19) United States
(12) Patent Application Publication
(10) Pub. No.: US 2009/0171256 A1
(43) Pub. Date: Jul. 2, 2009

(54) PORTABLE PERSONAL DEVICE FOR PULMONARY VENTILATION AND RESUSITATION AT NEGATIVE AND POSITIVE INTERMITTENT PRESSURES

(76) Inventor: Andrea Fiorina, Albenga (IT)

Correspondence Address: MICHAEL G. GILMAN, 5522 RIVA RIDGE DRIVE, WESLEY CHAPEL, FL, 33544, US

(21) Appl. No.: 12/227,156

(22) PCT Filed: May 12, 2006
(86) PCT No.: PCT/IT2006/000357

§ 371 Date: Nov. 7, 2008

(51) Int. Cl. A61H 31/02

(52) U.S. Cl. 601/44

(57) ABSTRACT

The present invention relates to a portable-personal device (1) for pulmonary ventilation and resuscitation at negative and positive intermittent pressures, useful for aiding respiration of patients suffering from acute and chronic respiratory insufficiency. It consists of an artificial, portable, small, wearable, light, silent respiratory device that can be easily used by the patient who is thus permitted to lead as normal a life as possible.

### BRIEF DESCRIPTION OF THE INVENTION

Object of this invention is a portable-personal device for pulmonary ventilation and resuscitation at negative and positive intermittent pressures, useful for aiding respiration of patients suffering from acute and chronic respiratory insufficiency. It consists of an artificial, portable, small, wearable, light, silent respiratory device that can be easily used by the patient who is thus permitted to lead as normal a life as possible.

### STATE OF THE ART

Patients affected by respiratory insufficiency often require assisted ventilation to facilitate pulmonary ventilation and consequent respiratory air exchange.

The intensity of respiratory movements derived from assisted respiration, together with periods of time and pressures to be defined by the medical doctor, differ depending on the predefined purposes: respiration, respiratory rehabilitation, partial rest of the respiratory muscles, resuscitation.

With the aim to provide assistance for patients affected by acute or chronic respiratory insufficiency, several devices have been provided in the past which were based on the application on the patient's thorax and abdomen of a closed box delimiting a sealed gap between said box and the patient's body: an intermittent negative and/or negative and positive pressure is applied to said gap.

The negative pressure applied outside the patient's thorax determines a negative pressure inside the airways thus provoking an inspired air flow, while a positive pressure, on the contrary, provokes expiration air flow.

The first example of artificial ventilation using negative extra-thoracic pressure is represented by a device worked out in the first half of the 1800's consisting of a type of box sealed around the neck and the thorax of the patient to create a sealed system, to which a negative intermittent pressure was applied operating on the patient's thorax so favouring the air movement in/out the patient's lungs.

The artificial ventilation device, named “iron lung” was invented in 1928: it was the most important invention for artificial ventilation, in spite of its enormous size, heavy weight and, consequently, very high cost.

In the following years other models of iron lung have been realized at lower cost, so that their use was favoured also in respiratory insufficiencies due to neuro-muscular diseases such as poliomyelitis.

In 1980 a new generation of negative pressure ventilators co-ordinated with the inspiratory movements of the patients was available on the market: these devices improved the patient's respiratory comfort and gave a great impulse to the negative pressure assisted ventilation.

As an example of devices for assisting patients affected by respiratory insufficiency there may be cited those of U.S. Pat. No. 4,424,806, U.S. Pat. No. 2,480,980 and DE 1 103 523. A modern iron lung is essentially formed by a large box, inside of which the patient's body is placed, except the head that leans out through a sealed opening, and by a piston or a pump, operated by an electric motor, producing some cyclic variations of pressure inside the box. This iron lung induces on the patient's thorax some sufficiently comfortable and physiologic movements and permits regulation of the negative pressures during the inspiration, to optionally supply positive pressures during the expiration by establishing the periods of time of the respiratory cycle. The device can also be heated and inclined in a caudal-cranial direction for an optional postural drain. The patient inside the iron lung can be assisted by a dedicated team, that can use, for the purpose, some lateral openings located on the iron lung. The modern iron lung, in its entirety, is still big, heavy and still expensive and moreover it immobilizes the patient in a fixed position.

A further device for assisting patients affected by acute or chronic respiratory insufficiency is represented by the “chest cuirasse”, which consists of a plastic rigid shell-shaped bell which embraces, while sealing, the anterior surface of the thorax and a portion of the patient's abdomen, and of a pump to create negative and positive pressures. This device, light and portable, may be also used at home, but it requires that the shell-shaped bell be tailored to the single thorax to avoid air leakages. Moreover the pressures exerted around the body of the patient are uncomfortable after one or two hours of operation, and can even cause thorax and dorsal pains and skin lesions.

Yet a further device useful for helping patients affected by respiratory insufficiency is the “poncho”. It is formed by a nylon covering with a rigid, flat portion, supporting the back, and a rigid shell-shaped portion anchored to the flat portion; inside the device are located the thorax and the abdomen of the patient. The poncho is then sealed around the neck, the wrists, the pelvis and the ankles of the patient. A negative pressure is intermittently applied on the surface of the thorax and the abdomen. Although poncho is better tolerated than the cuirasse, it may provoke back pains because of its rigid flat dorsal portion and also, sometimes, the patients complain of coldness.

With these more recent devices, the artificial pulmonary ventilation method is non-invasive, easy to use and also allows respiratory muscles to rest. During the functioning of the ventilator it is also possible to aspire the secretions and effect bronchoscopes without any interruptions of the ventilation. Finally there is no interference with cough, phonation and deglutition mechanisms.

However, parallel to these useful characteristics there are some disadvantages: these are represented by a reduced accessibility to the patient (venous access, E.C.G., and so on), except for the iron lung, by a possible airways collapse in correspondence with tongue base, or by a missed pre-inspiration activation of the pharynx muscles. It is also difficult to monitor the current volume and the minute volume ventilation.

In the last years of the last century a device was put on the market using non-invasive, positive pressure ventilation via nasal mask. This assisted ventilation device is small, light and portable. Non-invasive positive pressure ventilation is largely used for supporting patients affected by acute or chronic ventilatory inefficiency. Said device, however, presents some disadvantages such as: it prevents the patients from communicating easily, it can provoke facial or oral sores, it makes eating difficult and it can cause gastric distension from hyper insufflations.

Negative or negative/positive pressure ventilation (as in the iron lung) is clearly superior in respect to the nasal positive pressure ventilation as to the patient's comfort is concerned, because it allows the patient to speak and does not require sedation: the patient does not fight with the ventilation device. This type of ventilation improves the patient's cardiac output rather than reducing it, as occurs with positive pressure ventilation. During negative pressure ventilation, the mean intra-thoracic pressure decreases and the venous return is facilitated. The ventilation pattern, using intermittent negative pressure around the chest wall, is the most physiological artificial ventilation type for moving the air inside the lungs, in a way similar to the respiratory pattern of the patient under unassisted spontaneous respiration. This type of ventilation facilitates the clearance of secretions, it permits the execution of bronchial suction in bronchoscopy and in tracheal intubations, even if these manoeuvres may cause the risk of bacterial super infections.

The portable negative pressure ventilation devices now available are not as efficient as the iron lung which involves the whole body; sore difficulties may be present consisting in: air leakages at seals around the neck, arms and hips in connecting the patient; the presence sometimes of a cooling effect to the patient; in any case a prevention to the patient's motility.

It is therefore desirable to have available a portable negative-positive pressure ventilation device which is light, wearable, usable during normal life, discreet, silenced, noiseless, comfortable, easy to be used by patients and by medical doctors.

### DESCRIPTION OF THE INVENTION

The object of the present invention is an improved negative and positive intermittent pressure ventilation device useful for assisting respiration of patients affected by acute or chronic respiratory insufficiency.

Said device consists of a personal artificial respiratory ventilator that provides the patient the most possible normal respiratory pattern and may correct the muscular paradoxal movements during a predetermined personal respiratory cycle, without having the inconveniencies of the prior art artificial devices.

The device object of the invention is essentially made up of an artificial thoracic cage configured, when in use, around the patient's thorax, connected to the abdomen wall by a sealing inextensible belt that contains a flat balloon of small size and of a suitable air pump that produces the intermittent negative and positive pressures, either inside the gap formed between the patient's thorax and the artificial thoracic cage or inside said flat balloon located on the abdominal anterior region.

These two portions, artificial thoracic cage and abdominal portion, are tightly linked to each other and work together contemporaneously to produce a regular respiratory cycle that can be varied and regulated by the medical doctor for different purposes: respiration aid and air exchange, thoracic physical training, resuscitation (cardio-pulmonary compression).

The pressures produced by negative and positive ventilation allow expansion and reduction of thoracic diameters of the patient and, consequently, the air flow in and out the airways.

The flat balloon is blocked by the above-mentioned inextensible belt on the abdominal wall, in turn blocked by a system of inextensible braces constrained to the patient's legs. This system permits a rhythmic movement of the abdominal wall and, consequently, an ascending and descending movement of the diaphragm muscle during the respiratory cycle is favoured.

An automatic feedback system is incorporated in the device to allow personal adjustments as to the air volume, respiratory rate, inspiration and expiration ratio; it also allows synchronization with spontaneous breathing.

The shape and size of the artificial thoracic cage are designed, as would be for a personal prosthesis, according to the patient's type and pathology. It is also possible to have available some standard sizes for the most frequent types of patients encountered during clinical practice.

The main characteristic of the device of the invention consists in an artificial thoracic cage essentially parallel to the patient's thoracic cage, between the two thoracic cages, the artificial and the natural ones, being formed a very thin gap, put sufficient to avoid mechanical and/or thermal problems on the cutaneous surface such as decubitus sores, erythemas, pruritus, etc., which could occur during operation. The small size of the gap, formed between the two thoracic cages, however, takes into consideration the patient's physical constitution as well as the alternating movements of inspiration and expiration.

A further important use of the device of the invention is to restore and to make more efficient the cardiopulmonary compression.

When the blood circulation of a patient is inadequate, for example during a cardiac arrest, a very efficient component of the resuscitation process is the rhythmic chest compression. Pressing and relieving, by hand, the chest wall near the sternum creates alternative positive and negative intra-thoracic pressure which, in turn, taking effect on the cardiac valves, translates into an increased and then decreased intra-ventricular pressure to generate a forward blood flow.

However, when the chest is pressed, the amplitude of the intra-thoracic pressure elevation is reduced by the downward displacement of the diaphragm.

When the pressure applied to the chest is removed, the recoiling forces stored in the chest wall during the compression create a negative intra-thoracic pressure which facilitates venous blood return and refilling of the atria and ventricles.

The device of the present invention is useful for co-ordinating thoracic cage movements and for opposing to abdominal components so that, during resuscitation manoeuvres, the amplitude of positive and negative intra-thoracic pressure increases in an optimal way during a cycle of chest compression.

### DETAILED DESCRIPTION OF THE INVENTION

For a better comprehension of the invention, reference is made to the attached drawings that, however, should not be considered limiting the scope of the same.

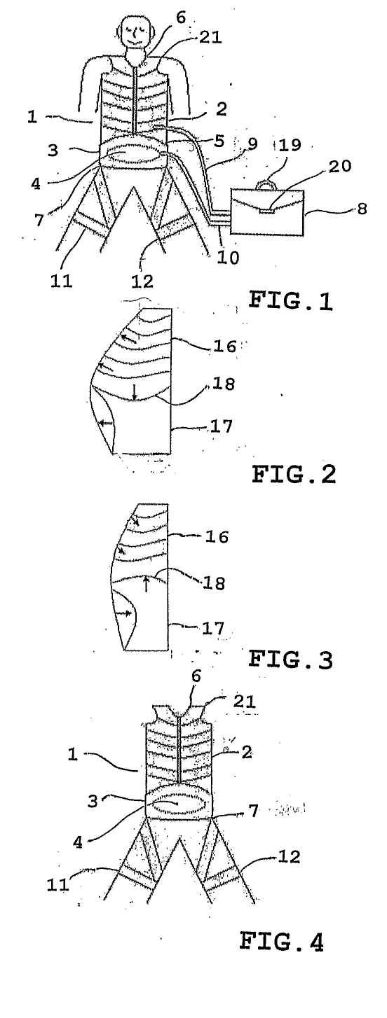

FIG. 1 shows a schematic front view of a patient wearing the device of the invention;

FIG. 2 shows a schematic partial lateral view of the device of the invention, wherein the arrows show the pressures applied on the thorax, on the abdomen and on the diaphragm of the patient during the inspiration phase;

FIG. 3 shows a schematic partial lateral view of the device of the invention, wherein the arrows show the pressures applied on the thorax, on the abdomen and on the diaphragm of the patient during the expiration phase;

FIG. 4 shows a schematic partial front view of the device of the invention;

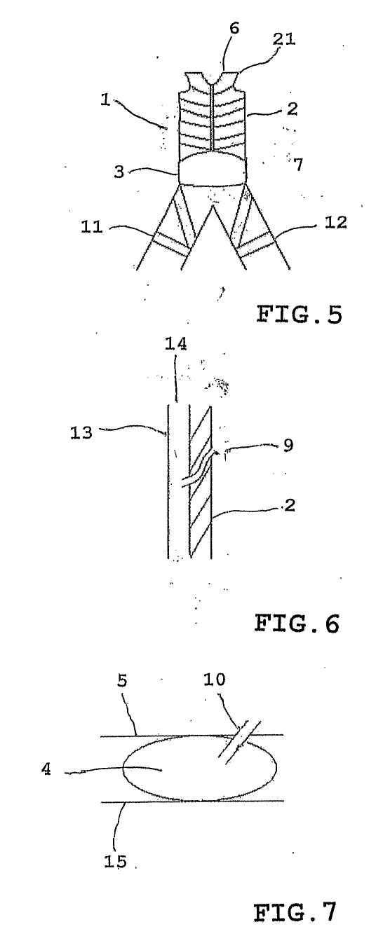

FIG. 5 shows a schematic partial back view of the device of the invention;

FIG. 6 shows a schematic cross section view of a small portion of the thoracic zone of the device of the invention, when applied to the patient;

FIG. 7 shows a schematic cross section view, in a horizontal plane in correspondence to the maximal horizontal section of the flat balloon of the device of the invention, when applied on the abdominal surface of the patient.

In these figures are shown: the ventilation device (1) as a whole, consisting of: the wearable thoracic cage (2); the wearable abdominal portion (3), this portion being formed by an anatomic flat small balloon (4) placed on the abdominal surface (15) of the patient and held in position by an inextensible seal belt (5) that tightly joins the thoracic cage (2) and the abdominal portion (3); the annulus collars (6),(7),(21), located around the neck, the abdomen and the arms of the patient respectively, in such a way not to interfere with the blood circulation, but effective to guarantee a seal of the device against the patient's skin, so creating a sealed gap inside the artificial thoracic cage (2); a small suitcase (8), such as a 24 hour bag, inside provided with a piston inserted in a suitable cylinder, or a pump, both moved by an electric motor, which is integrated in an electric circuit with battery—in the case of pump this should be of a sucking/forcing silenced type—and with a miniaturized control centre that regulates the set up respiratory parameters, i.e. the negative and positive pressures, the inspiratory and expiratory periods of time and finally the respiratory frequency, none of these elements contained in the small suitcase (8) being represented in the figures; the small non-deformable flexible pipes (9),(10) that connect the piston or the pump with thoracic cage (2) and the abdominal portion (3) respectively; the security braces (11),(12) that fasten the device through the abdominal belt (5), to right and left patient's legs respectively. The small suitcase (8) has a handle (19), for easy transportation, optionally also as a shoulder bag, and a traditional closure (20).

In these figures are also represented in detail: the rigid thoracic cage (2) that forms with the skin surface (13) of the patient's thoracic portion (16) the gap (14), wherein the air is pumped or sucked through the small, flexible and non-deformable pipe (9), by a piston or a pump; and the flat balloon (4) pressed between the skin (15) of the abdominal portion (17) of the patient, and the inextensible belt (5), wherein air is pumped or sucked through the small flexible non-deformable pipe (10) by the piston or the pump.

The arrows indicate the movements caused by the device (1), either on the thoracic portion (16) or on the abdominal portion (17) of the patient, and finally on the diaphragm (18), the latter lowering during the inspiration phase and raising during expiration phase.

The ventilation device (1), object of invention, can be manufactured, with regard to its thoracic cage (2), in two different alternative embodiments.

The first alternative embodiment foresees that the thoracic cage (2) be made up of two rigid portions each other blocked by a precision system, consisting of various specific dap joints, known in the art. Besides the block, these systems must guarantee the seal in respect to the air, under pressure or under depression, inside the gap between the patient's thorax (16) and the thoracic cage (2) of the device.

The second alternative embodiment foresees the manufacture of a thoracic cage (2) having horizontal lamellae, in different numbers, such as the imbricated lamellae of medieval cuirasses. These lamellae can slide one on the other for a very short run, a few millimetres, with a run end that prevents their detaching, so breaking the seal.

This second alternative embodiment, in respect to the first one, improves the characteristics of the device of the invention because it is better tolerated by patients, particularly in normal life movements, while maintaining the seal integral. Anyway, it is possible that during the patient's normal life movements, the lamellae thoracic cage (2), may produce noise and vibration, which, even of low intensity, may cause nuisance to the patient and/or embarrassment to bystanders.

The essentially horizontal lines in the figures, referring to the thoracic cage (2) of the device (1), have a different meaning according to the embodiment considered.

In the first alternative embodiment, i.e. when the thoracic cage (2) is manufactured in two rigid portions, these lines represent some stiffeners of the thoracic cage (2), which may be different depending on the characteristics of the material employed to make it non-deformable.

In the second alternative embodiment, i.e. when the thoracic cage (2) is manufactured with lamellae, these, in a variable number, preferably between 4 and 12, slide one on the other with a short run with a block at the end of the run, as previously described. The length of the run, of a few millimetres, and the number of the lamellae are variable depending on the materials employed and on the size of the patient who wears the device.

Also the inextensible abdominal belt (5) and braces (11) and (12) of the cuisses are divided in several portions so that the patients can wear the device (1) in a manner more suitable to their figure and to feel at ease. Once suitably blocked, for example by a Velcro material, the abdominal belt (5) has to absolutely guarantee the seal and ensure a comfortable status for the patients either at rest or during their normal life.

The device of negative and positive intermittent pressure ventilation, object of the present invention, permits therefore to obtain a variation of the dimensions of the patient's thorax, dependent on the increase or reduction of the pressure between the thoracic cage (2) and the patient's thorax (16).

Before using the device, in the miniaturized control centre inside the small suitcase (8), it is necessary to set up for each patient the most suitable ventilation program based on the parameters relevant to the negative and positive pressures, to the inspiratory and expiratory periods of time and finally to the respiratory frequency. Then the patient wears the device, both the thoracic cage (2) and the abdominal portion (3), the latter being formed by the small flat balloon (4) and by the inextensible belt (5) fixing it on the cuisses by means of the corresponding braces (11),(12) and making sure that the seal annulus (6),(7) and (21) be well positioned. After the connection of the thoracic cage (2) and the abdominal portion (3) to the piston or to the pump, located inside the small suitcase (8), by means of the small flexible, non-deformable pipes (9) and (10), the device can be switched on by pressing a button located inside the small suitcase (8).

During the working of the device, inside the gap (14), between the device cage (2) and the thorax of the patient (16), two different pressures are applied: the negative and the positive ones, as imitation of the respiratory cycle of a healthy subject, in a similar manner as in the operation of the iron lung.

Using the device of the invention, a modest movement of the artificial thoracic cage (2), during inspiration and expiration is observed, which permits a good adaptation of the patient wearing the device during his normal life; this is possible thanks to the size of the device and to the choice of the material employed.

At the same time in the abdominal portion (3), the small flat balloon (4) exerts a rhythmic pressure and depression that also, indirectly, permits some excursions of the diaphragmatic muscle: the device is also useful for expanding or compressing the lowest part of the lower thoracic wall (16) of the patient.

During operation of the device, it is necessary to maintain a comfortable body temperature inside the gap (14): this can be realised operating in a room at comfortable temperature and/or providing the patient with suitable clothes.

Construction materials of the device of the invention may be various, but with common characteristics such as lightness, robustness, adaptability to guarantee seal and biocompatibility with the skin of the patient. As suitable materials, polyethylene, neoprene, synthetic sponge or metallic materials, such as aluminium, may be used.

The device of the invention can be used in resuscitation therapy, because all the movements induced during functioning are also useful to provide a compression on the thoracic wall of patients affected by cardiovascular collapse and/or cardiac arrest; in this case it is necessary that the adjustment of the device parameters be regulated under continuous medical supervision.

A further application of the device of the invention is that it can be worn, with some structure changes, by aircraft pilots under the pressurized suit as resuscitation device or automatic device for favouring respiratory training during flights at high speed.

Finally, still a further non-negligible application of the device of the invention, consists in that, with some suitable modifications, calibration and appropriate instruments of measure, it can be also used for performing measurements of respiratory physiopathology and for evaluating the principal parameters of the pulmonary function. So, it can be used, for diagnostic purposes, as spirometer or corporeal modified mini-pletismograph.

1. A portable personal device for pulmonary ventilation (1) adapted to provide negative and positive intermittent pressures useful for assisting patients affected by acute or chronic respiratory insufficiency, wherein said device comprises material that is biocompatible with the human skin, wherein said device comprises an artificial thoracic cage (2) and an abdominal portion (3), both provided with seal systems (6), (7) and (21), wherein said artificial thorasic cage (2) and said abdominal portion (3) are tightly connected to each other, in a sealed manner, by an inextensible belt (5) that encloses a small flat balloon (4), wherein the abdominal portion (3) is provided with a system of substantially inextensible blocking braces (11) and (12), wherein said artificial thoracic cage (2) is substantially parallel to the natural thoracic cage (16) of the patient, wherein a gap (14) is formed in-between, the artificial thoracic cage (2) and natural thorasic cage (16) and a flat balloon (4) suitably connected to an element for air admission/emission, is incorporated in the device as a system for the a personalized regulation of the volume and pressure of the air, of the respiratory frequency, and of the inspiratory/expiratory ratio.

2. The portable personal device for pulmonary ventilation (1) according to claim 1, wherein the artificial thoracic cage (2) is formed of two rigid portions, each tightly connected to the other by precision systems with seal dap joints, and further provided with suitable stiffeners where needed.

3. The portable personal device for pulmonary ventilation (1) according to claim 1, wherein the artificial thoracic cage (2) comprises a plurality of horizontal imbricated seal lamellae having at least one run end.

4. The portable personal device for pulmonary ventilation (1) according to claim 3, comprising 4 to 12 horizontal lamillae.

5. The portable personal device for pulmonary ventilation (1) according to claim 1, wherein said admission/emission of the air is provided by a piston adapted to move axially in a cylinder.

6. The portable personal device for pulmonary ventilation (1) according to claim 1, wherein said admission/emission of the air is provided by a sucking/pressing pump that is adapted to move ambient air.

7. A method for assisting in the care of acute and chronic respiratory insufficiency in patients in need thereof comprising treating said patient with a device as claimed in claim 1.

8. A method for assisting in the resuscitation of a patient in need thereof comprising treating said patient with a device as claimed in claim 1.

9. A method of aiding respiratory training in patients in need thereof comprising applying the portable personal device of pulmonary ventilation (1) as claimed in claim 1 to said patient.

10. Carrying out diagnostic measurement for respiratory physiopathology in patients in need thereof by applying the portable personal device for pulmonary ventilation (1) according to claim 1 to said patient.
